(19) United States
(12) Patent Application Publication
(10) Pub. No.: US 2015/0348725 A1
(43) Pub. Date: Dec. 3, 2015

(54) SUB-ASSEMBLING METHOD, SUB-ASSEMBLED UNIT, AND APPARATUS WITH SUB-ASSEMBLED UNIT

(71) Applicant: Kabushiki Kaisha Toshiba, Tokyo (JP)

(72) Inventor: Tomoaki Tamura, Hamura Tokyo (JP)

(21) Appl. No.: 14/670,187

(22) Filed: Mar. 26, 2015

Related U.S. Application Data
(60) Provisional application No. 62/003,923, filed on May 28, 2014.

(51) Int. Cl. H01H 13/704; B32B 37/02; B32B 37/18; H01H 13/86; B32B 3/26; B32B 7/04; G06F 3/02; H01H 13/83; B32B 37/00; B32B 27/06

(52) U.S. Cl. CPC H01H 13/704; B32B 37/0084; B32B 37/02; B32B 37/182; B32B 27/06; B32B 3/266; B32B 7/045; G06F 3/0202; H01H 13/83; H01H 13/86; B32B 2250/03; B32B 2307/302; B32B 2307/412; B32B 2457/00; H01H 2219/062; H01H 2219/044

(57) ABSTRACT

According to one embodiment, a sub-assembling method for producing a sub-assembled unit including an attaching surface by combining a rigid member and a thermoplastic resin, the sub-assembling method includes fitting, welding and adhering. In the fitting, a pin of the thermoplastic resin is fit into a hole of the rigid member penetrating on a side of the attaching surface. In the welding, a tip of the pin protruding from the hole is welded on a recessed portion formed around the hole on the side of the attaching surface. In the adhering, a sheet punched at a portion corresponding to the recessed portion of the rigid member is adhered to the rigid member so as to provide the attaching surface.

### CROSS-REFERENCE TO RELATED APPLICATIONS

This application claims the benefit of U.S. Provisional Application No. 62/003,923, filed May 28, 2014, the entire contents of which are incorporated herein by reference.

### FIELD

Embodiments described herein relate generally to a sub-assembling method, a sub-assembled unit, and an apparatus with the sub-assembled unit.

### BACKGROUND

Some products such as electronic apparatuses are formed by combining metallic components and synthetic resin components. When a metallic component and a synthetic resin component are joined and fixed to each other, various methods such as securing by screws, fitting, adhering, deforming and fixing the metallic component, welding the synthetic resin component, and injection molding the synthetic resin inserting the metallic component, etc., can be adopted. When the synthetic resin is a thermoplastic resin and is not removed during maintenance, the synthetic resin component can be fixed to the metallic component by welding. Welded components of components adopted into a precision instrument are required to have assembling and manufacturing tolerances with a high degree of accuracy.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a cross-sectional view of a connected portion of a sub-assembled unit assembled by a sub-assembling method of a first embodiment.

FIG. 2 is a cross-sectional view showing a state obtained immediately before a pin of a thermoplastic resin is fit into a hole of a rigid member of the sub-assembled unit of FIG. 1.

FIG. 3 is a cross-sectional view showing a state in which the pin is melted by a welding apparatus after the rigid member and the thermoplastic resin of the sub-assembled unit of FIG. 2 are combined.

FIG. 4 is a cross-sectional view showing a state in which the welding apparatus has begun to be separated from the rigid member after the pin is welded in FIG. 3.

FIG. 5 is an exploded perspective view showing a keyboard as a sub-assembled unit of a second embodiment seen from an attaching portion.

FIG. 6 is an exploded perspective view in which a keyboard is adopted as a sub-assembled unit to an apparatus of a third embodiment.

### DETAILED DESCRIPTION

Various embodiments will be described hereinafter with reference to the accompanying drawings.

In general, according to one embodiment, a sub-assembling method for producing a sub-assembled unit comprising an attaching surface by combining a rigid member and a thermoplastic resin, the sub-assembling method includes fitting, welding and adhering. In the fitting, a pin of the thermoplastic resin is fit into a hole of the rigid member penetrating on a side of the attaching surface. In the welding, a tip of the pin protruding from the hole is welded to a recessed portion formed around the hole on the side of the attaching surface. In the adhering, a sheet punched at a portion corresponding to the recessed portion of the rigid member is adhered to the rigid member to provide the attaching surface. The sub-assembling method can maintain the flatness of the attaching surface of the sub-assembled unit after the pin of the thermoplastic resin is welded on the hole of the rigid member.

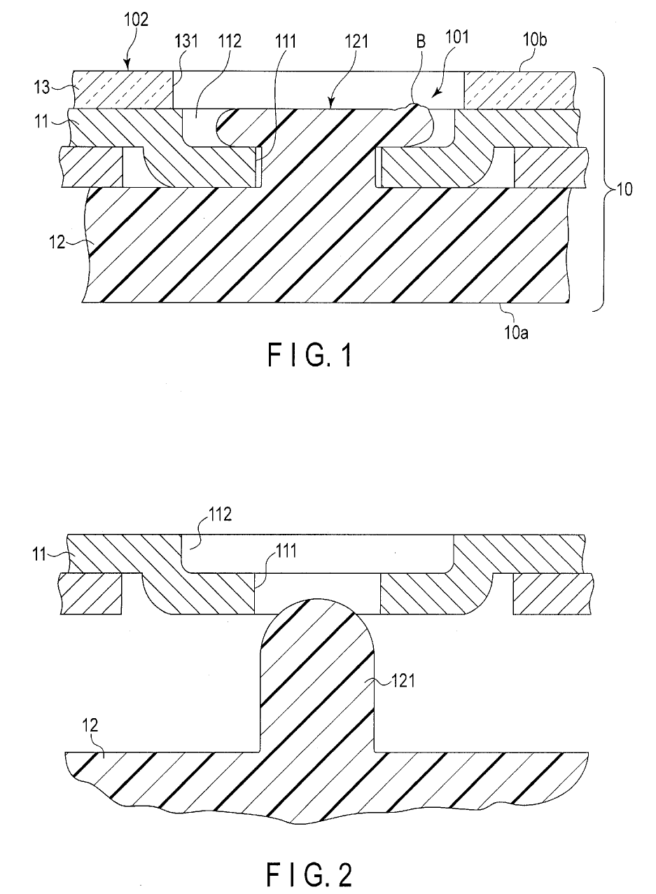

A sub-assembling method of a first embodiment will be described with reference to FIG. 1 to FIG. 4. FIG. 1 shows a cross section of a connected portion 101 between a rigid member 11 and a thermoplastic resin 12 of a sub-assembled unit 10 assembled by the sub-assembling method. The sub-assembled unit 10 has an attaching surface 102 so as to be incorporated into a product and used. As shown in FIG. 1, the connected portion 101 of the sub-assembled unit 10 is comprised of the rigid member 11, the thermoplastic resin 12 and a sheet 13.

The rigid member 11 comprises a hole 111 penetrating from the side of the attaching surface 102 to the opposite side thereof, and a recessed portion 112 formed around the hole 111 on the side of the attaching surface 102. The rigid member 11 may be formed of a metal or a synthetic resin, if it can bear the strength of the assembled sub-assembled unit 10. If the rigid member 11 is formed of a metal, the rigid member 11 can be cheaply manufactured by performing die-cut and bending at the same time by means of press forming such as punching. The rigid member 11 is formed by overlapping two members in FIG. 1, but may also be formed of one member.

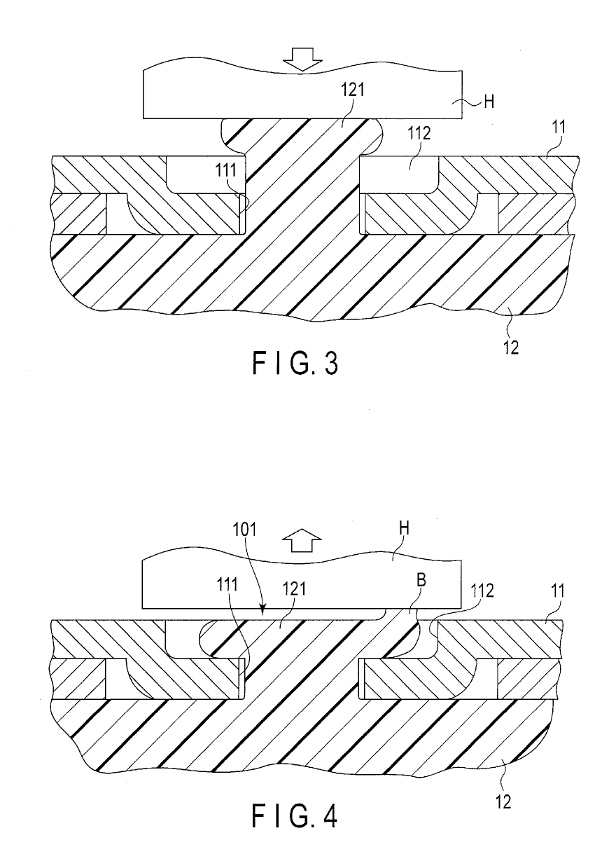

As shown in FIG. 2, the thermoplastic resin 12 integrally comprises a pin 121 to be fit into the hole 111 of the rigid member 11. A tip of the pin 121 protrudes to the side of the recessed portion 112 in a state of combining the thermoplastic resin 12 with the rigid member 11. If the sub-assembled unit 10 assembled by the above-described sub-assembling method is large, a plurality of holes 111 of the rigid member 11 and a plurality of pins 121 of the thermoplastic resin 12 are formed as connected portions 101. When the pin 121 is fit into the hole 111 and the thermoplastic resin 12 is combined with the rigid member 11, a heated head H of a welding apparatus gets close to the recessed portion 112 of the rigid member 11, and the tip of the pin 121 is thereby melted and flattened out in the recessed portion 112, as shown in FIG. 3.

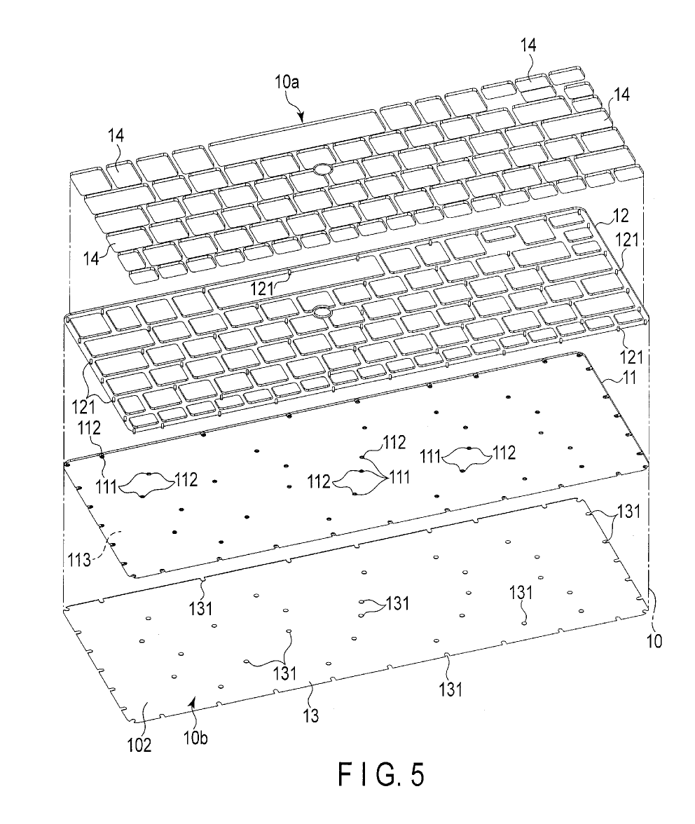

The head H of the welding apparatus is pushed against the rigid member 11 such that the melted pin 121 is contained in the recessed portion 112 of the rigid member 11. It is preferable that the welding apparatus does not form a burr B at the melted pin 121 when the head H is separated from the rigid member 11. Actually, however, the melted pin 121 sticks to the head H and a small burr B is formed as shown in FIG. 4. The burr B is pulled by the head H and protrudes to the outside of the recessed portion 112 owing to the structure of the recessed portion 112 of the rigid member 11 and the head H of the welding apparatus.

In the present embodiment, the sheet 13 is adhered to the rigid member 11 after welding as shown in FIG. 1. The sheet 13 may be adhered to the rigid member 11 by adhesive or double-sided adhesive tape, or a periphery may be adhered by adhesive tape. The sheet 13 has a thickness greater than a tolerance of the burr B of the pin 121 formed by welding, and a portion of the sheet 13 corresponding to the recessed portion 112 is punched. A hole 131 punched in the sheet 13 is somewhat larger than an external form of the recessed portion 112 formed on the rigid member 11. Even if the burr B is formed on the tip of the welded pin 121, flatness of the attaching surface 102 is maintained by the adhered sheet 13. In the present embodiment, since a material of the sheet 13 merely needs to have a uniform thickness, the sheet 13 may be formed of a metal or a synthetic resin.

The sub-assembled unit 10 of a second embodiment will be described as a keyboard unit with reference to FIG. 5. The constituent elements having the same functions as those of the sub-assembled unit 10 of the first embodiment are denoted by the same reference numbers in the following descriptions and the drawings, and the descriptions and drawings of the first embodiment are considered for the detailed descriptions.

FIG. 5 is an exploded perspective view showing a keyboard unit as an embodiment of the sub-assembled unit 10 seen from the side of the attaching surface 102. As shown in FIG. 5, the sub-assembled unit 10 which is to be a keyboard comprises a plurality of key tops 14, the thermoplastic resin 12 serving as a frame, the rigid member 11 serving as a base plate, and the sheet 13 serving as a lightguide plate.

When the side on which the key tops 11 are mounted is an upper surface 10a of the sub-assembled unit 10, a lower surface 10b of the sub-assembled unit 10 is the attaching surface 102. Pins 121 are arranged on an outer periphery and portions located between the key tops 14 of the frame, on the lower surface of the thermoplastic resin 12 facing the rigid member 11. Holes 111 penetrate in a thickness direction at positions on the rigid member 11 corresponding to the pins 121, and recessed portions 112 are formed around the holes 111 on the side of the lower surface of the rigid member 11. The rigid member 11 comprises a substrate 113 arranged to face the side of the thermoplastic resin 12 and having contact points at positions corresponding to the respective key tops 14, supporting members which support the respective key tops 14 to allow the key tops 14 to be pressed, and springs (cup-shaped elastomers in this case) for returning the pressed key tops 14 to the initial positions.

In the sub-assembled unit 10 of the second embodiment, the sheet 13 is formed of a transparent synthetic resin member which propagates light, and serves as a lightguide plate. Therefore, the sub-assembled unit 10 further comprises a light source unit on the side of the lower surface of the sheet 13. The light source unit includes light-emitting diodes (LEDs) interspersed within a range overlapping the sheet 13. The optical unit is adhered to the lower surface of the sheet 13 together with a film for efficiently reflecting light output from the LEDs on the sheet 13 serving as a lightguide plate. Holes may be punched in the sheet 13 in accordance with positions of the LEDs.

Windows are formed on the rigid member 11 and the substrate 113 to output the light propagated by the sheet 13 to the side of the key tops 14. Each of the key tops 14 has a light transmissive portion which allows the light propagated by the sheet 13 to pass through, for example, a letter portion corresponding to each of the key tops 14. The letters of the key tops 14 thereby emit light. It should be noted that holes 131 punched at positions on the sheet 13 corresponding to the recessed portions 112 do not interfere with guidance of the light from the light source unit to the light transmissive portions of the key tops 14 since each of the connected portions 101 between the holes 111 and the pins 121 is located at a position where the key top 14 is not positioned.

In the above-described sub-assembled unit 10, the pins 121 of the thermoplastic resin 12 are inserted into the respective holes 111 of the rigid member 11 to which the substrate 113 is adhered and the supporting members, etc., of the key tops 14 are mounted, and welding is performed at once. The shape of each of the pins 121 before and after welding has been described in the first embodiment. After the pins 121 are welded, the sheet 13 serving as a lightguide plate is adhered to the lower surface of the rigid member 11, and a reflection film and a light-shielding film are further adhered thereto together with the light source unit.

The sheet 13 of the present embodiment has a function of a lightguide plate in addition to a function of maintaining the flatness of the attaching surface 102 of the sub-assembled unit 10. Therefore, the mounting efficiency of an apparatus which adopts the above-described sub-assembled unit 10 is increased.

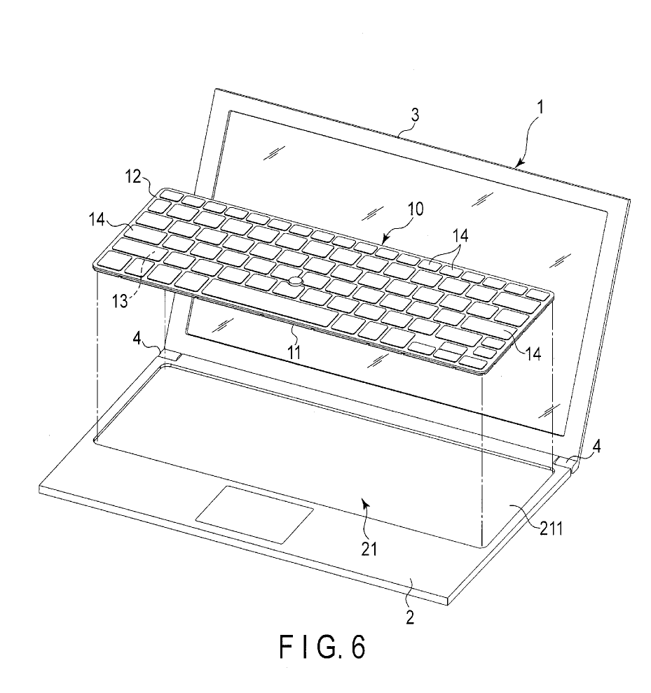

Next, an apparatus 1 of a third embodiment will be described as a portable computer with reference to FIG. 6. The constituent elements having the same functions as those of the sub-assembled unit 10 of the first embodiment or the constituent elements having the same functions as those of the sub-assembled unit 10 of the second embodiment are denoted by the same reference numbers as those of the sub-assembled unit 10 of the first embodiment or the second embodiment in the following descriptions and the drawings, and the descriptions and drawings of the first or second embodiment are considered for the detailed descriptions.

The apparatus 1 shown in FIG. 6 is a so-called clamshell-type portable computer, and comprises a first housing 2 on which a sub-assembled unit 10 is provided as a keyboard unit serving as an input module, a second housing 3 on which a display module is provided, and a hinge 4 which connects the first housing 2 and the second housing 3 to each other. The sub-assembled unit 10 is a keyboard unit described in the second embodiment, and is adhered to a bottom face 211 by double-sided adhesive tape or adhesive agent after a wiring (e.g. a flexible wiring board) extending from a mounted portion 21 formed by recessing an upper surface of the first housing 2 is connected to a connector of the sub-assembled unit 10, or a wiring (e.g. a flexible wiring) extending from the sub-assembled unit 10 is connected to a connector provided in the mounted portion 21.

Similarly to the first or second embodiment, the sub-assembled unit 10 of the third embodiment comprises the sheet 13. Therefore, even if the burr B is formed at the tip of the pin 121 by welding as shown in FIG. 4, the flatness of the attaching surface 102 of the sub-assembled unit 10 can be maintained as shown in FIG. 1.

In the apparatus 1 of the third embodiment configured as described above, since the attaching surface 102 is flat, the sub-assembled unit 10 is not come off because of age deterioration when the sub-assembled unit 10 is adhered to the mounted portion 21 of the first housing 2 only by adhesive or double-sided adhesive tape. In addition, the construction management of the burr B formed at the tip of the welded pin 121 is facilitated.

In the second embodiment, an example in which the sheet 13 is a lightguide plate has been described in detail. However, if the letters of the key tops 14 are not made to emit the light, the sheet 13 does not need to be a lightguide plate. By forming the sheet 13 of a conductive member such as foil of aluminum alloy or stainless alloy, a radio wave radiated from electronic components inside the first housing 2 can be prevented from leaking to the side of the mounted portion 21. In addition, heat generated by the electronic components inside the first housing 2 can be easily dissipated. Furthermore, a member which has anisotropy in thermal conductivity, i.e., of which thermal conductivity in the in-plane direction of the sheet 13 is larger than thermal conductivity in the out-of-plane direction, such as a layered member may be adopted as the sheet 13. Since the heat radiation area of the sheet 13 is expanded by the rapid spread of the heat transmitted from the electronic components along the surface of the sheet 13, the heat radiation efficiency of the apparatus 1 is increased.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A sub-assembling method for producing a sub-assembled unit comprising an attaching surface by combining a rigid member and a thermoplastic resin, the method comprising:
fitting a pin of the thermoplastic resin into a hole of the rigid member penetrating on a side of the attaching surface;
welding a tip of the pin protruding from the hole to a recessed portion around the hole on the side of the attaching surface; and
adhering a sheet punched at a portion corresponding to the recessed portion, to the rigid member to provide the attaching surface.

2. A sub-assembled unit with an attaching surface comprising:
a rigid member comprising a hole penetrating on a side of the attaching surface and a recessed portion on the side of the attaching surface around the hole;
a thermoplastic resin comprising a pin inserted into the hole, the tip of the pin protruding from the hole and welded to the recessed portion; and
a sheet punched at a portion corresponding to the recessed portion and adhered to the rigid member.

3. The sub-assembled unit of claim 2, wherein the sheet has an electrical conductivity.

4. The sub-assembled unit of claim 2, wherein the sheet is a transparent synthetic resin member and propagates light.

5. The sub-assembled unit of claim 2, wherein the sheet has a thermal conductivity in an in-plane direction higher than a thermal conductivity in an out-of-plane direction.

6. An apparatus with a sub-assembled unit comprising:
a housing comprising a mounted surface on an external surface; and
the sub-assembled unit comprising an attaching surface to be adhered and fixed to the mounted surface,
wherein the sub-assembled unit comprises:
a rigid member comprising a hole penetrating on a side of the attaching surface and a recessed portion formed on a side of the attaching surface around the hole;
a thermoplastic resin comprising a pin inserted into the hole, the tip of the pin protruding from the hole and welded to the recessed portion; and
a sheet punched at a portion corresponding to the recessed portion and adhered to the rigid member.

7. The apparatus of claim 6, wherein
the sub-assembled unit includes a keyboard unit, the sub-assembled unit comprising:
a plurality of key tops arranged on a side of the synthetic resin member, at least some of key tops comprising a light transmissive portion; and
a light source inserted between the sheet and the mounted portion; and
the sheet propagates light from the light source to the key tops.
